(19) United States
(12) Patent Application Publication
(10) Pub. No.: US 2025/0131796 A1
(43) Pub. Date: Apr. 24, 2025

(54) DISPLAYING MULTIPLE PROGRESSIVES

(71) Applicant: IGT, Las Vegas, NV (US)

(72) Inventors: Dwayne NELSON, Las Vegas, NV (US); Kevin HIGGINS, Las Vegas, NV (US)

(73) Assignee: IGT, Las Vegas, NV (US)

(21) Appl. No.: 18/491,476

(22) Filed: Oct. 20, 2023

(51) Int. Cl. G07F 17/32

(52) U.S. Cl. CPC G07F 17/3258; G07F 17/3211; G07F 17/3225

(57) ABSTRACT

Systems, devices and methods are provided. A system includes a communication interface, a processor circuit and a memory coupled to the embodiments. The memory includes machine readable instructions that, when executed by the processor circuit, cause the processor circuit to receive, via a communication interface, progressive prize data corresponding to multiple progressive wagering games and from multiple electronic gaming machines. The processor circuit may be further caused to generate multiple updated progressive wagering game composite values that each correspond to one of the progressive wagering games. The processor circuit may be further caused to transmit data corresponding to the updated progressive wagering game composite values to the display device that is configured to display each of the updated progressive wagering game composite values.

### BACKGROUND OF THE DISCLOSURE

Some players enjoy playing a variety of slot games in a wagering session at a casino. A casino operator may be able to dynamically add and remove games from electronic gaming machines (EGMs) on the casino floor. Changing slot games that include complex progressive games may be particularly difficult in the context of multiple progressive games being in a bank of EGMs.

A floor management application may be used to install, remove and configure games. As such, a floor management application may be useful for setting up complex progressive games. This may lead to customers installing multiple linked progressive games on an EGM. It may be challenging to determine which progressive display information to show for multiple progressives.

### BRIEF SUMMARY OF THE DISCLOSURE

Some embodiments are directed to systems that include a communication interface, a processor circuit and a memory coupled to the embodiments. The memory includes machine readable instructions that, when executed by the processor circuit, cause the processor circuit to receive, via a communication interface, progressive prize data corresponding to multiple progressive wagering games and from multiple electronic gaming machines. The processor circuit may be further caused to generate multiple updated progressive wagering game composite values that each correspond to one of the progressive wagering games. The processor circuit may be further caused to transmit data corresponding to the updated progressive wagering game composite values to the display device that is configured to display each of the updated progressive wagering game composite values. The processor circuit that was caused to transmit the data corresponding to the updated progressive wagering game composite values is further caused to transmit game-specific graphics that include corresponding ones of the updated progressive wagering game composite values. In some embodiments, a display device is caused to display respective ones of the game-specific graphics at respective portions of the display device. Some embodiments provide that the respective portions of the display device include multiple zones that are displayed on the display device.

Some embodiments are directed to methods that include operations. Such operations may include receiving, via a communication interface, progressive prize data corresponding to multiple progressive wagering games and from multiple EGMs. Operations may further include generating multiple updated progressive wagering game composite values that each correspond to one of the progressive wagering games and transmitting data corresponding to the updated progressive wagering game composite values to a display device that is configured to display each of the updated progressive wagering game composite values. In some embodiments, respective portions of the display device include multiple zones that are displayed on the display device. Some embodiments provide that a quantity of the zones is less than a quantity of the electronic gaming machines.

Some embodiments are directed to a gaming device that includes a communication interface, a processor circuit, and a memory coupled to the processor circuit, the memory comprising machine readable instructions that, when executed by the processor circuit, cause the processor circuit to perform operations including receiving, via the communication interface, progressive prize data corresponding to multiple progressive wagering games and from multiple electronic gaming machines. Operations include generating multiple updated progressive wagering game composite values that each correspond to one of the progressive wagering games and transmitting data corresponding to the updated progressive wagering game composite values to a display device that is configured to display each of the updated progressive wagering game composite values. In some embodiments, the display device includes a first display device on a first side of a bank of the electronic gaming machines and a second display device on a second side of the bank of the electronic gaming machines. Some embodiments provide that the electronic gaming machines include a first portion of the electronic gaming machines that include a first bank of electronic gaming machines and a second portion of the electronic gaming machines that include a second bank of electronic gaming machines. Some embodiments provide that the first display device is configured to display progressive prize data corresponding to electronic gaming machines that are in the first bank and the second display device is configured to display progressive data corresponding to electronic gaming machines that are in the second bank.

### BRIEF DESCRIPTION OF THE DRAWINGS

FIG. 1 is a schematic block diagram illustrating a standalone progressive jackpot with one or more progressive pools and/or levels maintained by the EGM or game software itself according to some embodiments.

FIG. 2 is a schematic block diagram illustrating a progressive controller maintained and/or managed progressive jackpot with one or more progressive pools and/or levels maintained by the EGM or game software itself according to some embodiments.

FIG. 3 is a schematic block diagram illustrating a progressive controller maintained and/or managed progressive jackpot with one or more EGMs across multiple casino sites according to some embodiments.

FIG. 4 is a schematic block diagram illustrating an example bank of EGMs according to some embodiments.

FIG. 5 is a schematic block diagram illustrating embodiments including a bank of EGMs according to some embodiments.

FIG. 6 is a schematic block diagram illustrating embodiments with example separate progressive controller displays that display signage.

FIG. 7 is a schematic block diagram illustrating two progressive displays on a progressive controller in different configurations according to some embodiments.

FIG. 8 is a schematic block diagram illustrating system components for providing two progressive games according to some embodiments herein.

FIG. 9 is a schematic block diagram that illustrates a multiple progressive display according to some embodiments herein.

FIG. 10 is a schematic block diagram that illustrates a display change responsive to one of the displayed jackpots having a hit according to some embodiments.

FIG. 11 is a schematic block diagram illustrating multiple sized game assets displayed according to some embodiments.

FIG. 12 is a schematic block diagram illustrating multiple sized game assets in a picture in picture display according to some embodiments.

FIG. 13 illustrates a casino management system including a plurality of gaming devices according to some embodiments herein.

FIG. 14 is a block diagram that illustrates various components of a computing device, which may embody or be included as part of the devices, systems, and/or components above, according to some embodiments.

FIG. 15 is a schematic flow diagram illustrating operations of a system for displaying multiple progressives according to some embodiments.

### DETAILED DESCRIPTION OF THE DISCLOSURE

According to some embodiments herein, there is a push to allow customers to dynamically add and remove games from the EGMs on the casino floor. Some operators may use a floor management application to install, remove and/or configure games. Some embodiments provide that a floor management application may be useful for setting up complex progressive games. This may lead to customers installing multiple linked progressive games on an EGM. Since a bank of EGMs may have a single sign, challenges regarding which progressive display information to show on the signage may occur. Embodiments herein may address such challenges. Further, according to some embodiments, a single progressive controller and sign for a bank of multiple progressive games may be provided in a modular and configurable manner. Embodiments herein may accomplish the same goal of providing signage for progressive EGMs using less hardware, such as monitors and/or controllers, among others.

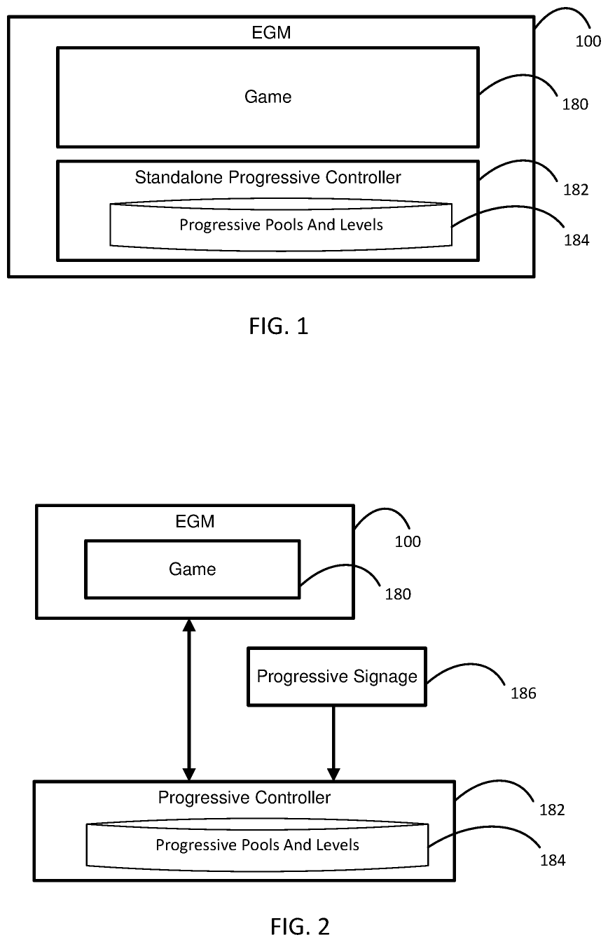

Brief reference is now made to FIG. 1, which is a schematic block diagram illustrating a standalone progressive jackpot with one or more progressive pools and/or levels maintained by the EGM or game software itself according to some embodiments. As illustrated, embodiments may include an EGM 100 that is operable to provide a game 180 that includes a progressive jackpot game 180. In some embodiments, a stand-alone progressive controller 182 may maintain and/or manage the progressive jackpot game 180 including progressive pools and levels 184 of the progressive jackpot game 180.

Brief reference is now made to FIG. 2, which is a schematic block diagram illustrating a progressive controller maintained and/or managed progressive jackpot with one or more progressive pools and/or levels that are maintained by the EGM or game software itself. As illustrated, embodiments may include an EGM 100 that is operable to provide a progressive jackpot game 180. A progressive controller 182 may maintain and/or manage the progressive jackpot game 180 including progressive pools and/or levels 184.

Embodiments may include a symbol driven progressive jackpot game 180 managed by a progressive controller 182 connected to one or more EGMs 100 in a casino site. This progressive controller 182 can be separate from an existing casino system and/or be a component of the existing casino system.

The functions of the progressive controller 182 may also be performed by an EGM 100. For example, in a bank of eight EGMs 100, one EGM 100 can perform the role of the progressive controller 182. In some embodiments, this configuration may be used when progressive signage 186 is not necessary and there may be an opportunity to avoid the cost of the progressive controller 182.

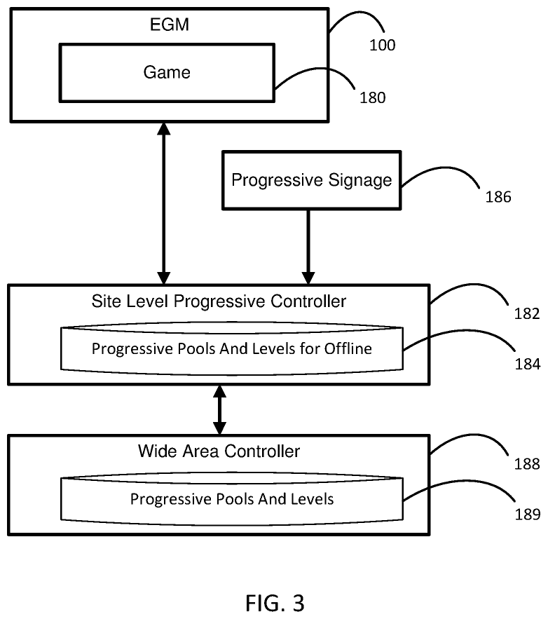

Reference is now made to FIG. 3, which is a schematic block diagram illustrating a progressive controller maintained and/or managed progressive jackpot with one or more EGMs across multiple casino sites according to some embodiments. As illustrated, embodiments may include an EGM 100 that is operable to provide a progressive jackpot game 180. A progressive controller 182 may maintain and/or manage the progressive jackpot game 180 including progressive pools and/or levels 184 corresponding to periods in which the site level progressive controller 182 is off-line.

Some embodiments provide that site level progressive controller 182 may not be used in some instances. For example, some embodiments provide that the site level progressive controller is used based on the game including multiple levels. In such embodiments, the EGM can communicate with the Wide Area Controller directly. In some embodiments, there may be a sign controller instead of the site level progressive controller when there are no progressive levels on the site level progressive controller.

Embodiments may include a symbol driven progressive jackpot game 180 managed by a site level progressive controller 182 that may be directly and/or indirectly connected to a wide-area controller 188 and/or one or more EGMs 100 at different casino sites. The wide area controller 188 may maintain and/or manage progressive pools and/or levels 189 corresponding to multiple casino sites.

In some embodiments, all of the casino sites can be associated with the same operator while other embodiments provide that the casino sites may be associated with multiple different casino operators.

Some embodiments provide that mystery progressives can also be associated with one or more games on one or more EGMs 100. Mystery progressives may not typically be associated with changes in the game math of the underlying game. As a result, the award trigger may not be associated with one or more wins determined by the game's paytable (paylines, etc). Instead, mystery progressive awards may be determined by a mystery progressive controller. Some embodiments provide that determining when a mystery progressive award is hit may include a magic number approach in which the controller is configured with a progressive level value range that the mystery must hit within and a Random Number Generator (RNG) determines a value within that range where a winner is chosen when the level hits that value. In some embodiments, the magic number may be determined when the mystery progressive controller initializes the level, such as, for example, on initial setup or after a hit.

In some embodiments, the mystery progressive may include a magic time approach in which the controller is configured with a time range that the mystery must hit within (ex: in the next week). A RNG may be used by the mystery progressive controller to determine a time within that range that the mystery progressive level will hit. In some embodiments, the magic time may be determined when the controller initializes the level, such as, for example, on initial setup or after a hit.

Mystery progressives can be run by an EGM 100, a bank controller for a bank or site, and/or one or more controllers that coordinate mystery progressive levels across EGMs at one or more sites, including across multiple casino operators. As used herein, the term bank controller may refer to a progressive controller that may be provided for multiple EGMs in a bank of EGMs.

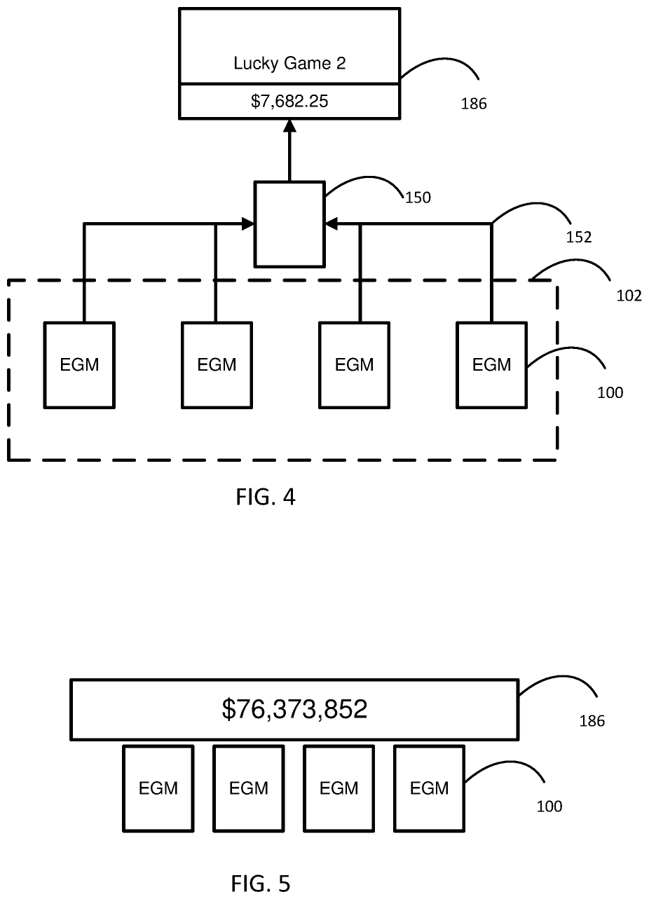

Reference is now made to FIG. 4, which is a schematic block diagram illustrating an example bank of EGMs 100 according to some embodiments. Embodiments may include an example bank 102 including multiple EGMs 100 that provide a linked progressive. The EGMs 100 communicate with a bank controller 150. The bank controller 150 may be illustrated as a single device, however, the disclosure is not so limited. For example, the bank controller 150 may be implemented as multiple bank controller devices. In some embodiments, the bank controller 150 may provide support for progressive management for a link 152 and the display 186 that provides the signage information. In some embodiments, the EGMs 100 communicate with the bank controller 150 using ethernet and/or some other communication protocol. For the progressive management, the bank controller 150 allows EGMs 100 to join a progressive group (e.g., “Lucky Game 2”), contribute to the progressive, query the progressive and ultimately win the progressive. The bank controller 150 may show the current value of one or more levels. In this example, one level shows the amount of $7,682.25. Each EGM 100 may have Lucky Game 2 installed. The bank controller 150 may display information to one or more monitors 186 using video standards such as HDMI and/or display port, among others.

Brief reference is now made FIG. 5, which is a schematic block diagram illustrating embodiments including a bank of EGMs 100 according to some embodiments. Each EGM 100 may allow multiple progressive games 180 to be installed onto the progressive controller 182. This may allow the player to choose between progressive games and links. In some embodiments, the customer only needs a single controller 182 and display to display the progressive signage 186. In such embodiments, the multiple EGMs 100 may have different progressive games 180 while only having the single display for signage 186. Such embodiments may reduce cost by using a single controller to provide multiple progressives.

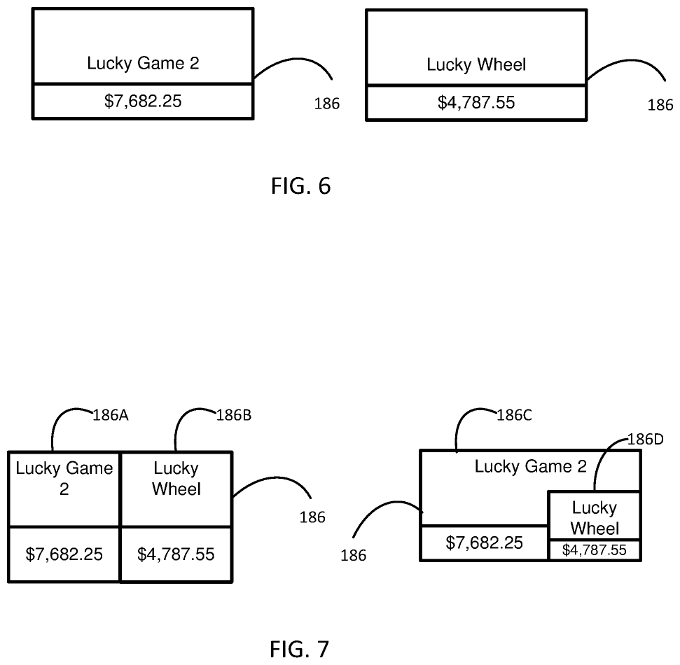

Brief reference is now made to FIG. 6, which is a schematic block diagram illustrating embodiments with example separate progressive controller displays that display signage 186. For example, the separate progressive controller displays may include a display for a first game (Lucky Game 2) and a display for second game (Lucky Wheel).

Brief reference is made to FIG. 7, which is a schematic block diagram illustrating two progressive displays on a progressive controller 182 in different configurations according to some embodiments. In some embodiments, the display signage 186 may provide the first display signage 186A (Lucky Game 2) on a left display section and the second display signage 186B (Lucky Wheel) on a right section of the display signage 186. Thus, these embodiments include providing the displays side by side.

Additionally, in some embodiments, the display signage 186 may provide the first display signage 186C (Lucky Game 2) as a primary display that covers substantially all of the display and the second display signage 186D (Lucky Wheel) on a portion of the display 186. Thus, these embodiments include providing the displays as picture-in-picture. While the current example provides for two progressive displays, embodiments herein are not so limited as there may be 3 or more progressive displays.

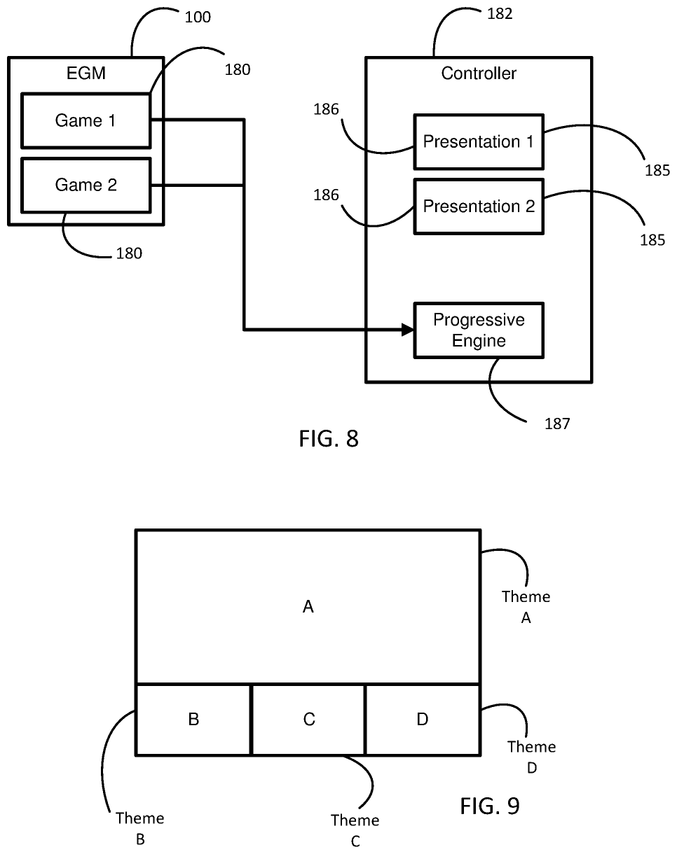

Brief reference is now made to FIG. 8, which is a schematic block diagram illustrating system components for providing two progressive games in accordance with some embodiments herein. As provided herein, the system components may be software, hardware and/or a combination thereof. System components may include components of the EGM 100 and bank controller 150. In some embodiments, the EGM 100 may have two progressive games 180 (Game 1 and Game 2). In some embodiments, the progressive games 180 may be installed onto the EGM 100 as one or more software packages.

The bank controller 182 may include one or more progressive engines 187. Although only one is illustrated, the bank controller 182 may include more than one progressive engine 178. The progressive engine 187 may manage the money and game play. Since the illustrated bank controller 182 includes two different graphical themes, there may be two presentation packages 185 installed on the bank controller 182 (Presentation 1 and Presentation 2). These presentation packages 185 may include graphics, sounds and/or computer program code to drive the monitors connected to the bank controller 182. In some embodiments, game packages may be installed directly on the EGM 100 by a technician and/or remotely using a host. Some embodiments provide that the presentation packages 185 may be installed on the bank controller 182 by a technician and/or remotely using a host. The EGM 100 and bank controller 182 can be configured by a technician and/or remotely using a host.

Some embodiments provide that to determine the layout, the system may be configured by the operator as a configuration of the bank controller 820. For example, the operator may choose the “side by side” option from the optional layouts including the types of layouts that can be selected. Layout types may include tiled, side by side, cycling, and/or picture in picture, among others.

In some embodiments, the size of the progressive display 186 shown on the monitor may be determined by a jackpot amount in which the larger the jackpot amount, the larger the display of the progressive display 186 is. Some embodiments provide that the number of people playing a respective game may be used to determine the size of the progressive display 186. For example, some embodiments may provide that the more people that are currently playing the game, the larger the display. In some embodiments, the progressive display size may be determined based on a contribution rate that identifies which of the progressives is bringing in more contributions at any given time and/or time interval. Some embodiments provide that the progressive display size may be determined based on the play rate. For example, the faster people are playing a progressive game, the greater the display size priority that the progressive game may receive. In some embodiments, this may incorporate a play rate that is eligible to win the progressive prize. For example, some lower tier wagers may not be eligible to win the progressive prize. In some further embodiments, the progressive display size may be determined randomly, by the status of a player, by the odds of a hit, and/or by the time since last hit. For example, the longest the time since the last hit may have a higher priority of display size than other more recently hit progressives.

Brief reference is now made to FIG. 9, which is a schematic block diagram that illustrates a multiple progressive display according to some embodiments herein. As illustrated, four progressive themes may be installed on the bank controller 150 (A, B, C and D). In this non-limiting example, theme A has the largest jackpot. While themes B, C and D are shown as being the same size as one another, such illustration is non-limiting. In some embodiments, theme A may be the largest, then theme B and then theme C and/or theme D and so on. The amount of time spent on each theme may be determined by the jackpot amount. For example, the larger the jackpot amount, the larger the display corresponding to that theme. The display sizes may be determined based on the number of people playing. For example, the more people currently playing the game, the larger the display relative to other display portions. The display sizes may be determined based on contribution rate and/or play rate. Some embodiments provide that a given play rate may provide eligibility to win the progressive at a given play rate and that lower tier wagers may not be eligible to win the progressive.

In some embodiments, the display sizes may be randomly determined and/or may be determined based on a status of a player, the odds of a hit and/or the time since the last hit. For example, a display corresponding to a progressive having a greater time since last hit may have a greater display priority than those that are hit more recently.

For example, if theme A had the largest current jackpot amount, then the display may be on theme A for 1 minute, then cycle to theme B for 5 seconds, theme C for 5 second and then theme D for 5 seconds.

In some embodiments, when the player status is used, the system may favor the themes being played by players with more status. Some embodiments provide that the status may be ranked by player loyalty account level and/or player points. In some embodiments, the status may be ranked by achievements in the casino system. For example, a bank of 8 EGMs may play various progressives in which four of the players are playing theme A and are loyalty members and four players are playing theme B and are not loyalty members. In this example, the bank controller 150 favors theme A and may adjust the displays accordingly.

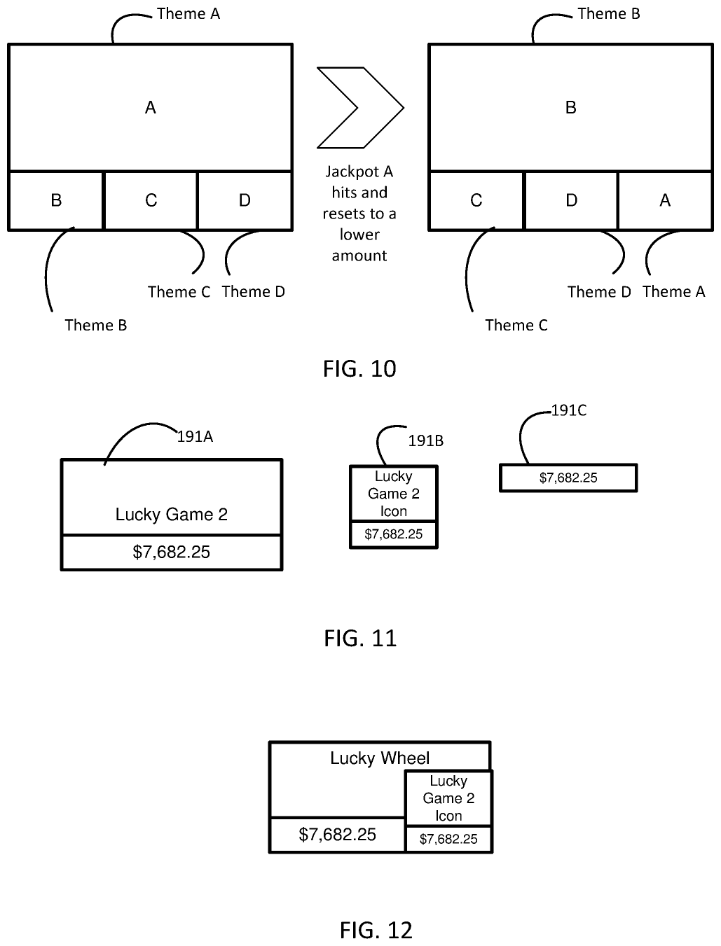

Brief reference is now made to FIG. 10, which is a schematic block diagram that illustrates a display change responsive to one of the displayed jackpots having a hit according to some embodiments. In some embodiments, an event may trigger a new layout decision. For example, some embodiments provide that when a jackpot (e.g., jackpot A) is hit, the system re-evaluates the layout and may reset jackpot A to a lower amount.

In some embodiments, the layout is evaluated on a periodic basis. For example, the layout may be evaluated and/or adjusted every 10 minutes. The 10 minute time interval is merely for example and does not limit embodiments herein. For example, the time interval may be more or less than 10 minutes. In some embodiments, the layout is evaluated after a certain amount of change in a progressive level. In some embodiments, the layout is evaluated after a software change on an EGM and/or when a jackpot is retired or added.

Brief reference is now made to FIG. 11, which is a schematic block diagram illustrating multiple sized game assets displayed according to some embodiments. In some embodiments, the bank controller 150 has a maximum number of themes that may be displayed at once and may have more than that number of progressive displays installed. For example, the bank controller 150 may be configured to show two displays in a side-by-side configuration. The bank controller 150 may have five progressive displays installed. The bank controller 150 may cycle the two displayed themes of the five possible themes using the already described priority and/or scaling systems.

In some embodiments, the bank controller 150 may be attached to a monitor that includes speakers and/or that includes separate speakers. In some embodiments, only the highest priority controller display provides sound to the players. In some embodiments, the volume of the sounds of the various presentations is scaled in the same manner as the video was scaled.

In some embodiments, responsive to the bank controller 150 determining the size and layout of the progressive themes, the controller software may query the presentation packages for different displays. For example, the presentation package may be installed on the bank controller 150 and may include three different layouts: small 191C, medium 191B and large 191A. The bank controller 150 informs the presentation package on which presentation package and/or asset to use for the current layout. In some embodiments, the presentation may not show the actual name 191A or icon 191B and may only show the amount 191C of the progressive.

Brief reference is now made to FIG. 12, which is a schematic block diagram illustrating multiple sized game assets in a picture in picture display according to some embodiments. As illustrated, the Lucky Wheel display uses the full-size graphics and fonts, while Lucky Game 2 is using a “medium” (or smaller) asset and fonts to accommodate the picture in picture layout.

In some embodiments, there may be presentations that the bank controller 150 may never show when in the multiple theme configuration. For example, the operator may choose to not show the progressive display on the sign for an old theme installed on the EGMs 100. In some embodiments, this may be tied to the previously described ranking parameters such as current amount. For example, some embodiments provide that the bank controller 150 may not display any progressive below $1,000.00.

While the previous examples focused on the bank controller 150 being associated with one monitor, the bank controller 150 may be associated with more than one monitor. For example, sometimes casino slot banks are configured back to back, with machines on either side of the bank. In such a configuration, two monitors may be configured, one to face each side of the bank. In such embodiments, the bank controller 150 may consider physical positioning information and/or associate certain displays with certain EGMs to determine what content to display. For example, if a given progressive game theme is only available from EGMs on one side of the bank, then the progressive controller 182 display information associated with that game theme may display on the appropriate display for that side of the bank (and not display on the other side of the bank). In this example, if the display on each side of the bank has other progressive information to display, it may apply the same algorithms mentioned previously, while pre-filtering the available content in a way that is tailored to the games available or associated with that display. Although discussed in the context of a back to back arrangement, embodiments herein are not so limited. For example, a triangle configuration may include displays that spread across multiple banks, including, for example, via remote connection using HDMI and/or Ethernet, among others.

Embodiments herein may work for casino games, video lottery terminal games, social casino games, mobile casino games and sports wagering terminals that offer progressive or mystery awards.

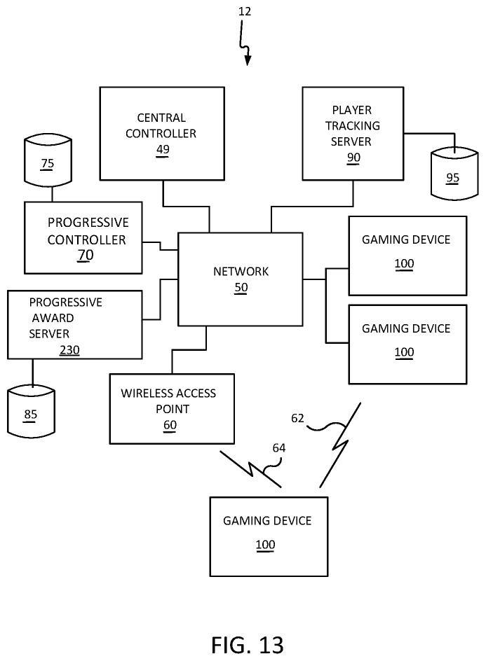

Reference is now made to FIG. 13, which illustrates a casino management system 12 including a plurality of gaming devices 100 according to some embodiments herein. The casino management system 12 may be located, for example, on the premises of a gaming establishment, such as a casino, in a private residence, or may include components that are located at different locations. The gaming devices 100 may be in communication with each other and/or a central controller 49 through a data communication network 50, or remote communication link. The data communication network 50 may be a private data communication network that is operated, for example, by the gaming facility that operates the gaming device 100, a publicly accessible data communication network such as the Internet, or a combination thereof. Communications over the data communication network 50 may be encrypted for security. The central controller 49 may be any suitable server or computing device which includes at least one processor circuit, such as a processor, and at least one memory or storage device. Each gaming device 100 may include a processor circuit that transmits and receives events, messages, commands or any other suitable data or signal between the gaming device 100 and the central controller 49 and/or other gaming devices 100. The gaming device processor is operable to execute such communicated events, messages or commands in conjunction with the operation of the gaming device 100. Moreover, the processor of the central controller 49 is configured to transmit and receive events, messages, commands or any other suitable data or signal between the central controller 49 and each of the individual gaming devices 100. In some embodiments, one or more of the functions of the central controller 49 may be performed by one or more gaming device processors. Moreover, in some embodiments, one or more of the functions of one or more gaming device processors as disclosed herein may be performed by the central controller 49.

A wireless access point 60 provides wireless access to the data communication network 50. The wireless access point 60 may be connected to the data communication network 50 as illustrated in FIG. 13 or may be connected directly to the central controller 49 or another server connected to the data communication network 50.

One or more servers, such as a player credit server 80, may also be connected through the data communication network 50. Similarly, the gaming content server 80 may manage delivery of the gaming content to the user of a gaming device 100. The gaming content may be stored in a gaming content database 85. A progressive controller 70 may manage access, update, storage, and/or progressive award and display data for multiple games. The progressive game and display data may be stored in a progressive controller database 75. The progressive controller 70 and a player credit server 80 may be implemented within or separately from each other. The progressive controller 70 and a progressive award server 230 may also be implemented within or separately from the central controller 49.

A player tracking server 90 may also be connected through the data communication network 50. The player tracking server 90 may manage a player tracking account that tracks the gameplay and spending and/or other player preferences and customizations of a player, i.e., the user of the gaming device 100, manages loyalty awards for the player, manages funds deposited or advanced on behalf of the player, and other functions. Player information managed by the player tracking server 90 may be stored in a player information database 95.

The gaming devices 100 communicate with one or more elements of the system 12 to coordinate providing streaming video content and synchronized gaming content. For example, in some embodiments, a gaming device 100 may communicate directly with another gaming device 100 over a wireless interface 62, which may be a WiFi link, a Bluetooth link, an NFC link, etc. In other embodiments, the gaming device 100 may communicate with the data communication network 50 (and devices connected thereto, including EGMs) over a wireless interface 64 with the wireless access point 60. The wireless interface 64 may include a WiFi link, a Bluetooth link, an NFC link, etc. In still further embodiments, the gaming device 100 may communicate with other gaming devices 100 or other devices over the wireless interface 62 and the wireless access point 60 over the wireless interface 64. In these embodiments, the wireless interface 62 and the wireless interface 64 may use different communication protocols and/or different communication resources, such as different frequencies, time slots, spreading codes, etc. For example, in some embodiments, the wireless interface 62 may be a Bluetooth link, while the wireless interface 64 may be a WiFi link.

The wireless interfaces 62, 64 allow the gaming devices 100 and/or central controller 49 to coordinate providing player data from gaming devices 100.

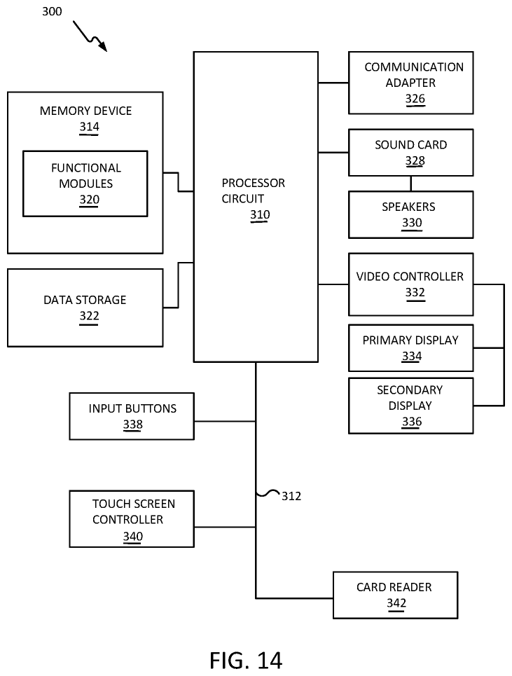

Reference is now to FIG. 14, which is a block diagram that illustrates various components of a computing device 300, which may embody or be included as part of the devices, systems, and/or components above, according to some embodiments. As shown in FIG. 14, the computing device 300 may include a processor circuit 310 that controls operations of the computing device 300. Although illustrated as a single processor, multiple special purpose and/or general-purpose processors and/or processor cores may be provided in the computing device 300. For example, the computing device 300 may include one or more of a video processor, a signal processor, a sound processor and/or a communication controller that performs one or more control functions within the computing device 300. The processor circuit 310 may be variously referred to as a “controller,” “microcontroller,” “microprocessor” or simply a “computer.” The processor circuit 310 may further include one or more application-specific integrated circuits (ASICs).

Various components of the computing device 300 are illustrated in FIG. 14 as being connected to the processor circuit 310. It will be appreciated that the components may be connected to the processor circuit 310 and/or each other through one or more buses 312 including a system bus, a communication bus and controller, such as a USB controller and USB bus, a network interface, or any other suitable type of connection.

The computing device 300 further includes a memory device 314 that stores one or more functional modules 320 for performing the operations described above. Alternatively, or in addition, some of the operations described above may be performed by other devices connected to the network, such as the network 50 of the peer-to-peer wagering system 12 of FIG. 2, for example. The computing device 300 may communicate with other devices connected to the network to facilitate performance of some of these operations. For example, the computing device 300 may communicate and coordinate with certain displays to identify elements of a race being displayed by a particular display.

The memory device 314 may store program code and instructions, executable by the processor circuit 310, to control the computing device 300. The memory device 314 may include random access memory (RAM), which can include non-volatile RAM (NVRAM), magnetic RAM (ARAM), ferroelectric RAM (FeRAM) and other forms as commonly understood in the gaming industry. In some embodiments, the memory device 314 may include read only memory (ROM). In some embodiments, the memory device 314 may include flash memory and/or EEPROM (electrically erasable programmable read only memory). Any other suitable magnetic, optical and/or semiconductor memory may operate in conjunction with the gaming device disclosed herein.

The computing device 300 may include a communication adapter 326 that enables the computing device 300 to communicate with remote devices, such as the wireless network, another computing device 300, and/or a wireless access point, over a wired and/or wireless communication network, such as a local area network (LAN), wide area network (WAN), cellular communication network, or other data communication network, e.g., the network 50 of FIG. 13.

The computing device 300 may include one or more internal or external communication ports that enable the processor circuit 310 to communicate with and to operate with internal or external peripheral devices, such as a sound card 328 and speakers 330, video controllers 332, a primary display 334, a secondary display 336, input buttons 338 or other devices such as switches, keyboards, pointer devices, and/or keypads, a touch screen controller 340, a card reader 342, currency acceptors and/or dispensers, cameras, sensors such as motion sensors, mass storage devices, microphones, haptic feedback devices, and/or wireless communication devices. In some embodiments, internal or external peripheral devices may communicate with the processor through a universal serial bus (USB) hub (not shown) connected to the processor circuit 310. Although illustrated as being integrated with the computing device 300, any of the components therein may be external to the computing device 300 and may be communicatively coupled thereto. Although not illustrated, the computing device 300 may further include a rechargeable and/or replaceable power device and/or power connection to a main power supply, such as a building power supply.

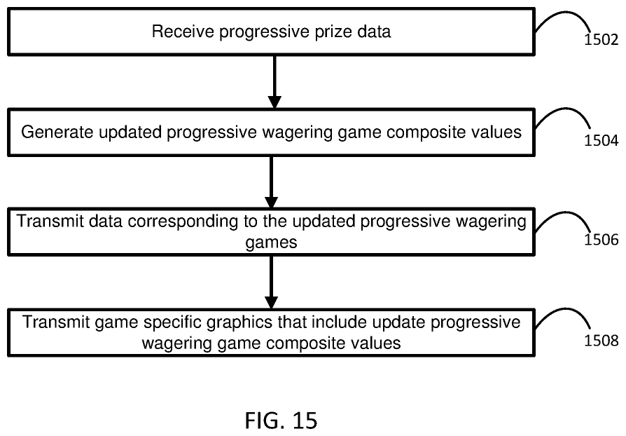

Brief reference is now made to FIG. 15, which is a schematic flow diagram illustrating operations of a system for displaying multiple progressives according to some embodiments. Operations include receiving (block 1502), via a communication interface, progressive prize data corresponding to multiple progressive wagering games and from multiple electronic gaming machines. Operations further include generating (block 1504) multiple updated progressive wagering game composite values that each correspond to one of the progressive wagering games. Operations further include transmitting (block 1506) data corresponding to the updated progressive wagering game composite values to the display device that is configured to display each of the updated progressive wagering game composite values.

In some embodiments, the processor circuit that transmits the data corresponding to the updated progressive wagering game composite values is further caused to transmit (block 1508) game-specific graphics that include corresponding ones of the updated progressive wagering game composite values. In some embodiments, a display device is caused to display respective ones of the game-specific graphics at respective portions of the display device. Some embodiments provide that the respective portions of the display device include multiple of zones that are displayed on the display device.

In some embodiments, ones of the zones include different zone locations and zone sizes that are dynamically determined. In some embodiments, ones of the zones are arranged side by side relative to one another.

In some embodiments, the zones include a first zone and a second zone that are arranged as a picture in a picture arrangement. Some embodiments provide that the first zone includes the whole display graphic and the second zone includes a fraction of the first zone. For example, the first zone may overlay a fractional portion of the first zone.

In some embodiments, the zones are graphically illustrated and are the same size as one another. In some embodiments, the zones include multiple graphically illustrated zones and the graphically illustrated zones include different sizes of zones. In some embodiments, the size of one of the zones is based on a jackpot amount relative to other zones. Some embodiments provide that the size of one of the zones is based on a player characteristic of a player playing one of the progressive wagering games. In some embodiments, the player characteristic includes the status of the player relative to other players. In some embodiments, the player characteristic includes a quantity of players that are playing the plurality of progressive wagering games. Some embodiments provide that a size of one of the zones is based on a time elapsed since jackpots on the progressive wagering games were last hit.

In some embodiments, game-specific graphics include first game-specific graphics associated with a first one of the electronic gaming machines and second game-specific graphics associated with a second one of the electronic gaming machines.

Some embodiments provide that the display device is configured to cyclically display the first and second game-specific graphics in respective portions of the display device. In some embodiments, cyclically displaying the first and second game-specific graphics includes serially displaying the first and second game-specific graphics based on a random selection.

In some embodiments, the zones include a first zone including a first size having a first orientation and first graphical content, a second zone including a second size having a second orientation and second graphical content, and a third zone having a third size including a third orientation and third graphical content.

Some embodiments provide that each of the zones includes presentations that are determined separately relative to other ones of the zones. Some embodiments provide that less than all of the zones are displayed.

Some embodiments include methods that include operations disclosed herein. Operations may include receiving, via a communication interface, progressive prize data corresponding to multiple progressive wagering games and from multiple EGMs. Operations may further include generating multiple updated progressive wagering game composite values that each correspond to one of the progressive wagering games and transmitting data corresponding to the updated progressive wagering game composite values to a display device that is configured to display each of the updated progressive wagering game composite values. In some embodiments, respective portions of the display device include multiple zones that are displayed on the display device. Some embodiments provide that a quantity of the zones is less than a quantity of the electronic gaming machines.

Some embodiments are directed to a gaming device that includes a communication interface, a processor circuit, and a memory coupled to the processor circuit, the memory comprising machine readable instructions that, when executed by the processor circuit, cause the processor circuit to perform operations including receiving, via the communication interface, progressive prize data corresponding to multiple progressive wagering games and from multiple electronic gaming machines. Operations include generating multiple updated progressive wagering game composite values that each correspond to one of the progressive wagering games and transmitting data corresponding to the updated progressive wagering game composite values to a display device that is configured to display each of the updated progressive wagering game composite values.

In some embodiments, the display device includes a first display device on a first side of a bank of the electronic gaming machines and a second display device on a second side of the bank of the electronic gaming machines. Some embodiments provide that the electronic gaming machines include a first portion of the electronic gaming machines that include a first bank of electronic gaming machines and a second portion of the electronic gaming machines that include a second bank of electronic gaming machines. Some embodiments provide that the first display device is configured to display progressive prize data corresponding to electronic gaming machines that are in the first bank and the second display device is configured to display progressive data corresponding to electronic gaming machines that are in the second bank.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

In some embodiments, a device, apparatus, system and/or computer program product may be described as causing a result and/or action. In such embodiments, causing may include actually performing the action and/or result and/or as performing any action that causes another device, apparatus, system and/or computer program product to cause the result or action.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a communication interface;
display device;
a processor circuit; and
a memory coupled to the processor circuit, the memory comprising machine readable instructions that, when executed by the processor circuit, cause the processor circuit to:
receive, via the communication interface, progressive prize data corresponding to a plurality of progressive wagering games and from a plurality of electronic gaming machines;
generate a plurality of updated progressive wagering game composite values that each correspond to one of the plurality of the progressive wagering games; and
transmit data corresponding to the plurality of updated progressive wagering game composite values to the display device that is configured to display each of the updated progressive wagering game composite values.

2. The system of claim 1, wherein the processor circuit caused to transmit the data corresponding to the plurality of updated progressive wagering game composite values is further caused to transmit game-specific graphics that comprise corresponding ones of the plurality of updated progressive wagering game composite values.

3. The system of claim 2, wherein the display device is caused to display respective ones of the game-specific graphics at respective portions of the display device, and
wherein the respective portions of the display device comprise a plurality of zones that is displayed on the display device.

4. The system of claim 3, wherein ones of the plurality of zones comprise different zone locations and zone sizes that are dynamically determined.

5. The system of claim 3, wherein ones of the plurality of zones are arranged side by side relative to one another.

6. The system of claim 3, wherein the plurality of zones comprises a first zone and a second zone that arranged as a picture in a picture arrangement, wherein the first zone comprises a whole display graphic and wherein the second zone comprises a fraction of the first zone and overlays a fractional portion of the first zone.

7. The system of claim 3, wherein the plurality of zones is graphically illustrated and are the same size as one another.

8. The system of claim 3, wherein the plurality of zones comprises a plurality of graphically illustrated zones, and wherein the plurality of graphically illustrated zones comprises different sizes of zones.

9. The system of claim 8, wherein a size of one of the plurality of zones is based on a jackpot amount relative to other ones of the plurality of zones.

10. The system of claim 8, wherein a size of one of the plurality of zones is based on a player characteristic of a player playing one of the plurality of progressive wagering games.

11. The system of claim 10, wherein the player characteristic comprises a status of the player relative to other players.

12. The system of claim 10, wherein the player characteristic comprises a quantity of players that are playing the plurality of progressive wagering games.

13. The system of claim 8, wherein a size of one of the plurality of zones is based on a time elapsed since jackpots on the plurality of progressive wagering games were last hit.

14. The system of claim 2, wherein the game-specific graphics comprise first game-specific graphics associated with a first one of the plurality of electronic gaming machines and second game-specific graphics associated with a second one of the plurality of electronic gaming machines, and
wherein the display device is configured to cyclically display the first and second game-specific graphics in respective portions of the display device.

15. The system of claim 14, wherein cyclically displaying the first and second game-specific graphics comprises serially displaying the first and second game-specific graphics based on a random selection.

16. The system of claim 3, wherein the plurality of zones comprises a first zone comprising a first size comprising a first orientation and first graphical content, a second zone comprising a second size comprising a second orientation and second graphical content, and a third zone comprising a third size comprising a third orientation and third graphical content.

17. The system of claim 3, wherein each of the plurality of zones comprises presentations that are determined separately relative to other ones of the plurality of zones.

18. The system of claim 3, wherein less than all of the plurality of zones are displayed.

19. A method comprising:
receiving, via a communication interface, progressive prize data corresponding to a plurality of progressive wagering games and from a plurality of electronic gaming machines;
generating a plurality of updated progressive wagering game composite values that each correspond to one of the plurality of the progressive wagering games; and
transmitting data corresponding to the plurality of updated progressive wagering game composite values to a display device that is configured to display each of the plurality of updated progressive wagering game composite values,
wherein respective portions of the display device comprise a plurality of zones that is displayed on the display device, and
wherein a quantity of the plurality of zones is less than a quantity of the electronic gaming machines.

20. A gaming device comprising:
a communication interface;
a processor circuit; and
a memory coupled to the processor circuit, the memory comprising machine readable instructions that, when executed by the processor circuit, cause the processor circuit to:
receive, via the communication interface, progressive prize data corresponding to a plurality of progressive wagering games and from a plurality of electronic gaming machines;
generate a plurality of updated progressive wagering game composite values that each correspond to one of the plurality of the progressive wagering games; and
transmit data corresponding to the plurality of updated progressive wagering game composite values to a display device that is configured to display each of the updated progressive wagering game composite values,
wherein the display device comprises a first display device on a first side of a bank of the electronic gaming machines and a second display device on a second side of the bank of the electronic gaming machines,
wherein the plurality of electronic gaming machines comprises a first portion of the electronic gaming machines that comprise a first bank of electronic gaming machines and a second portion of the electronic gaming machines that comprise a second bank of electronic gaming machines, and
wherein the first display device is configured to display progressive prize data corresponding to electronic gaming machines that are in the first bank and the second display device is configured to display progressive data corresponding to electronic gaming machines that are in the second bank.
